(19) United States
(12) Patent Application Publication
(10) Pub. No.: US 2010/0018263 A1
(43) Pub. Date: Jan. 28, 2010

(54) Restrainer

(76) Inventor: Ido Ben Yehuda, Tel Aviv (IL)

Correspondence Address: BROWDY AND NEIMARK, P.L.L.C.;624 NINTH STREET, NW, SUITE 300, WASHINGTON, DC, 20001-5303, US

(21) Appl. No.: 12/180,536

(22) Filed: Jul. 27, 2008

(51) Int. Cl. E05B 75/00

(52) U.S. Cl. 70/16; 70/275

(57) ABSTRACT

The “Restrainer” is geared towards rapid and safe control gaining, restraining and removal of certain individuals in various situations. The “Restrainer” gives a critical advantage by creating a higher physical leverage and supplys a firm safe and comfortable grip. The “Restrainer” acts as a restraining device, neutralizing device, removal device and arresting device, all according to mission characteristics and with a high reliability and minimum harm to the user and restrained individual.

### FIELD AND BACKGROUND OF THE INVENTION

This presented invention relates to the ability of representatives of the law to accost, grab, hold, restrain, apprehend and enforce the law over problematic individuals and complicated scenarios of use of force.

Sometimes it is necessary to rapidly gain control over certain individuals in various situations. Such individuals might be criminals, suspects, rioters etc. The need for such action arises when enforcing the law, riot control, crowd control, preventing escape, avoiding the need to inflict harm on the restrained. This basic need has existed for centuries, since the establishments of law and order and since sovereign governments had to enforce their laws and regulations.

Nowadays, under democratic regimes, the right to protest and the need to preserve public order sometimes clash. There is an increasing need for a quick, non-lethal adequate action, consequently, there is a need to:
A. gain control over an individual
B. restraint of an individual
C. distance an individual from the scene of violence riot
D. arrest the individual
E. counteract non-violent\passive civil disobedience or gathering

Various institutions utilize restraints, including law enforcement agencies, prison facilities, correctional facilities, asylums, security agencies, etc. sometimes just restraining the suspect may not be enough, in order to avoid the use of more drastic, harmful and sometimes lethal measures, it is desirable to provide such a restraint device that will allow quick distancing and removal of an individual as well as restraining him, without causing any serious harm.

### BRIEF DESCRIPTION OF THE FIGURES

FIG. 1 is a general schematic illustration which describes a first embodiment of the present invention;

FIG. 2 is a side view of a second embodiment of the restrainer according to the present invention;

FIG. 3 is an elevated view of a third embodiment of the present invention;

FIG. 4 is an exploded view of a fourth embodiment of the present invention;

FIG. 5 is a side cross sectional view of a fifth embodiment of the present invention; and

FIG. 6 is a cross sectional view of a sixth embodiment of the present invention.

The following illustrations describe few of the possibilities for the potential product and are not limiting or dictating in any way the final configuration of the Restrainer.

### DESCRIPTION OF THE PREFERRED EMBODIMENTS

It has been recognized that it would be advantageous to develop a method and device to enable a rapid and safe restraining and removal of a suspect. It has been also recognized that the suspect should not suffer any serious harm while being restrained and\or removed.

This present invention provides a restraint and removal device which can be quickly activated in order to achieve a firm holding of the suspect. The present invention consists of an ergonomic grip, connected to a unique cuff, which opens by Pressure\Contact or manual command and locks automatically or manually on the suspect's limb\joint.

The “Restrainer” allows the restrainer to use reasonable force, yet obtain maximum strength potential over the individual, by simply holding its grip once the “Restrainer” is locked and slightly tilting it if necessary. This is an advantageous alternative to securing an arm\limb\shirt with bare hands.

Once the “Restrainer” is locked, the Restrainer can easily remove\pull\lead the suspect from the scene to a temporary arrest location, where the same “Restrainer” can be used as a fixing device to prevent escaping. As well, according to mission characteristics, there is a possibility to connect several suspects together by attaching one “Restrainer” to another (chain connection).

Following are some of the advantages of the present invention:
Lightweight and convenient carrying when attached to a belt or a vest, or hand-held
User friendly operation and design
Quick action
Durable and firm structure
Non-lethal action
Generates leverage force over the restrained
Enables neutralization of the restrained arm
Enables quick marking of an individual amidst dense crowed for later apprehension
Enables arresting the suspect to a fixed location\fixing device
Enables locking a group of suspects together by chain connection of devices
Possibility of manual as well as automatic locking mechanism
Unlocking the device using a custom\master key

The principles and operation of the present invention may be better understood with reference to the drawings and the accompanying description. Before explaining at least one embodiment of the invention in detail, it is to be understood that the invention is not limited in its application to the details of construction and the arrangement of the components set forth in the following description and\or as illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

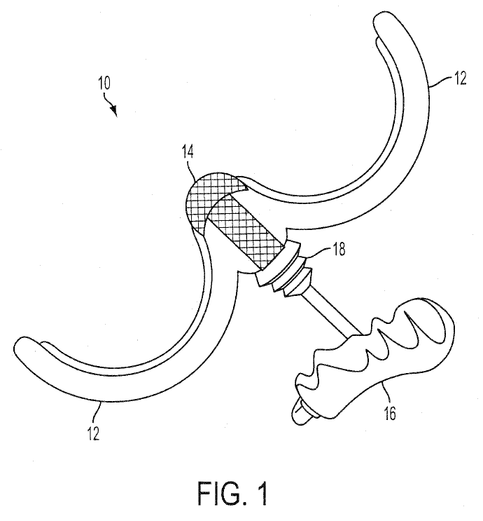

FIG. 1 shows a first embodiment of a first restrainer 10 according to the present invention.

Restrainer 10 preferably includes at least one, two are shown, claws 12 for readily retaining and/restraining a subject.

For the purpose of rapid deployment of restrainer 10, an activator 14 is provided such that pressure applied on activator 14 brings about a complimentary displacement of claws 12 such the claws 12 close around the wrist, arm or any other bodily part of the subject being restrained.

Preferably a handle 16 is provided for readily activating restrainer 10 and or readily applying restrainer 10 and/or manipulating the suspect by creating leverage on the limb or body part of the subject around which restrainer 10 is secured.

A “ratchet” mechanism 18 similar to such securing mechanism found in hand-cuffs is provided for preventing the subject from removing the restrainer prior to when desired by the retaining government body.

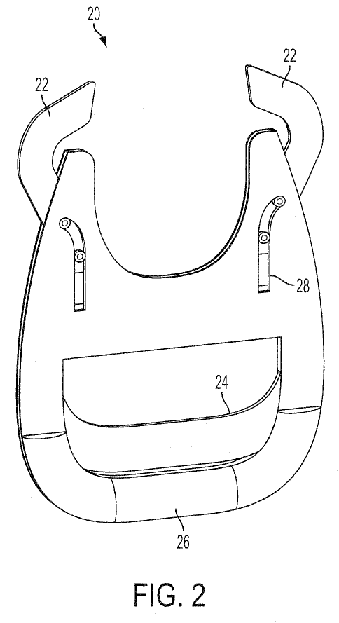

FIG. 2 shows a second preferred embodiment of the restrainer according to the present invention.

As shown, a second restrainer 20 preferably includes at least one, two are shown, clamps 22 for readily retaining and/restraining a subject.

For the purpose of rapid deployment of second restrainer 20, an activator 24 is provided such that pressure applied on activator 24 brings about a complimentary displacement of clamps 22 such the clamps 22 close around the wrist, arm or any other bodily part of the subject being restrained.

Preferably a handle 26 is provided for readily activating second restrainer 20 and or readily applying second restrainer 20 and/or manipulating the suspect by creating leverage on the limb or body part of the subject around which second restrainer 20 is secured.

A “locking” mechanism 28 is provided for preventing the subject from removing the restrainer prior to when desired by the retaining government body.

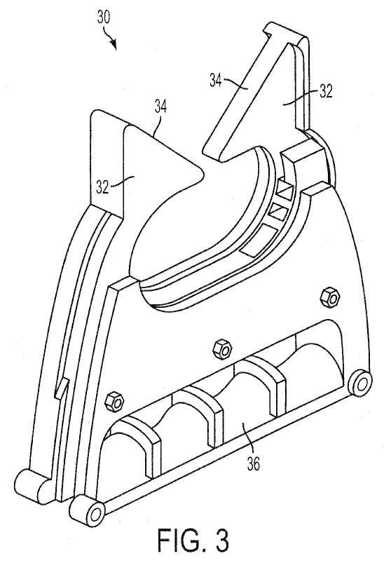

FIG. 3 shows a third preferred embodiment of the restrainer according to the present invention.

As shown, a third restrainer 30 preferably includes at least one, two are shown, “spring loaded” jaws 32 for readily retaining and/restraining a subject.

For the purpose of rapid deployment of third restrainer 30, an slide surface 34 is attached to or integrally formed with “spring loaded” jaws 32, such that pressure applied on any limb by slide surfaces 34 brings about a complimentary displacement of “spring loaded” jaws 32 such that the “spring loaded” jaws 32 close around the limb as soon as the limb has “cleared” slide surface 34 thereby retraining the subject.

Preferably a handle 36 is provided for readily controlling the restrained subject and/or manipulating the suspect by creating leverage on the limb or body part of the subject around which third restrainer 30 is secured.

A “locking” mechanism 38 is provided for preventing the subject from removing the restrainer prior to when desired by the retaining government body.

Preferably, “locking” mechanism 38 is an electronic locking mechanism which is encoded according to authorized users who bear a complimentary electronic key.

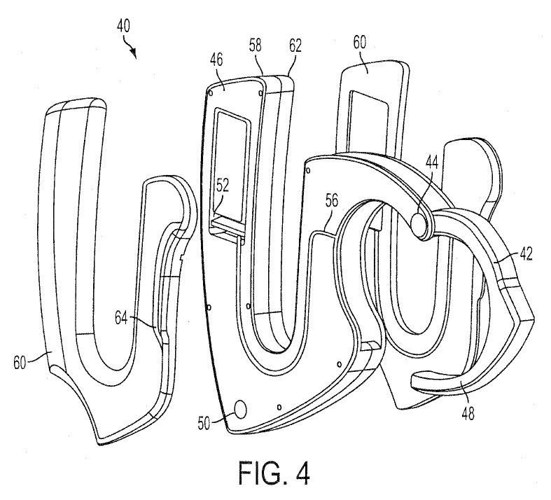

FIG. 4 shows an electronic embodiment of an electronic restrainer 40 according to the present invention.

Electronic restrainer 40 preferably includes at least one locking member 42 for readily retaining and/restraining a subject.

For the purpose of rapid deployment of electronic restrainer 40, locking member is preferably rotateably displaceable about a hinge 44 in manner similarly used in a variety of law enforcement restraining devices. Pressure applied on locking member 42 brings about a complimentary rotational displacement of locking member 42 about hinge 44 such that locking member 42 closes around the wrist, arm or any other bodily part of the subject being restrained.

Preferably a handle 46 is provided for readily applying electronic restrainer 40 and/or manipulating the suspect by creating leverage on the limb or body part of the subject around which electronic restrainer 40 is secured.

A “ratchet” mechanism 48 similar to such securing mechanism found in hand-cuffs is provided for preventing the subject from removing the restrainer prior to when desired by the retaining government body.

A lanyard loop 50 is provided for readily securing electronic restrainer 40 to as part of the equipment of the law enforcement, military or any other personnel using electronic restrainer 40.

Preferably, lanyard loop 50 is geared towards readily conjoining any number of electronic restrainers 40 to each other for use as handcuffs and/or linking several suspects to each other or even equipment to couriers or escorting individuals.

A power supply housing 52 is preferably formed within handle 46 for readily accommodating a power supply 54. Preferably, power supply 54 electronically attached to at least one conductive surface 56 for readily applying electrical current similar to “shockers” and other law enforcement products available in the market.

Preferably, handle 46 includes a wireless receiver 58 for readily remotely activating conductive surface 56, such that once a suspect has been “clamped” remote safe restraining procedures can be implemented.

Preferably, housing 52 is closed by at least one, two are shown, closures 60 which may act as an ergonomic “hand filler” as well.

Preferably, wireless receiver also includes a transmitter 62 for readily locating any individual restrained who may have tried to escape or is secured and/or detained in any location. During military operations, a large number of individuals are often secured and may require control and tracking. Likewise, in many correctional facilities, infractions and even riots can be prevented or quelled rapidly using electronic restrainers 40.

Optionally, a GPS receiver 64 can be attached to, or integrally formed with electronic restrainer 40 for readily locating individuals with extreme accuracy over large areas.

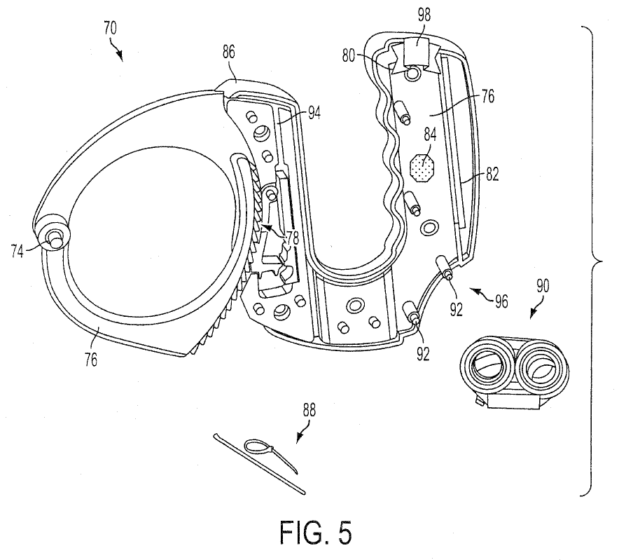

FIG. 5 shows a further embodiment of a restrainer 70 according to the present invention.

Restrainer 70 preferably includes at least one locking member 72 for readily retaining and/restraining a subject.

For the purpose of rapid deployment of restrainer 70, locking member 72 is preferably rotatably displaceable about a hinge 74 in manner similarly used in a variety of law enforcement restraining devices. Pressure applied on locking member 72 brings about a complimentary rotational displacement of locking member 72 about hinge 74 such that locking member 72 closes around the wrist, arm or any other bodily part of the subject being restrained.

Preferably a handle 76 is provided for readily applying restrainer 70 and/or manipulating the suspect by creating leverage on the limb or body part of the subject around which restrainer 70 is secured.

A “ratchet” mechanism 78 similar to such securing mechanism found in hand-cuffs is provided for preventing the subject from removing the restrainer prior to when desired by the retaining government body.

A lanyard loop 80 is provided for readily securing restrainer 70 to as part of the equipment of the law enforcement, military or any other personnel using restrainer 70.

Preferably, lanyard loop 80 is geared towards readily conjoining any number of restrainers 70 to each other for use as handcuffs and/or linking several suspects to each other or even equipment to couriers or escorting individuals.

Preferably, handle 76 is attached to or integrally formed with at least one, two are shown, closures 82 which may act as an ergonomic “hand filler” as well.

Preferably, wireless receiver also includes a transmitter 84 for readily locating any individual restrained who may have tried to escape or is secured and/or detained in any location. During military operations, a large number of individuals are often secured and may require control and tracking. Likewise, in many correctional facilities, infractions and even riots can be prevented or quelled rapidly using restrainers 70.

Optionally, a GPS receiver 86 can be attached to, or integrally formed with restrainer 70 for readily locating individuals with extreme accuracy over large areas.

Preferably, an additional limb retainer 88 is attached to, or integrally formed with restrainer 70 such that restrainer 70 can readily be used to restrain and\or secure and\or cuff any two limbs of a single individual and\or suspect or multiple suspects including but not limited to hands, legs, arms, digits and the like.

Preferably and as shown in FIG. 5, restrainer 70 readily accommodates a secondary restraining element 90. Secondary restraining element 90 is preferably attached to or integrally formed with restrainer 70 by way of a securer 92 for readily securing secondary restraining element to restrainer 70. Optionally, secondary restraining element 90 is selected from the group consisting of: a zip tie, a standard set of handcuffs, an additional restrainer 90, a zip cuff and the like.

Preferably, a locking mechanism 94 is provided to readily “lock” restrainer 70 thereby readily preventing “tampering” with restrainer 70. Optionally, locking mechanism 94 is analogous to handcuff locking mechanisms known in the art.

Preferably, restrainer 70 includes a recessed area 96 formed in restrainer 70 for readily accommodating a second limb of an individual after the first limb has been secured by locking member 72. Preferably, recessed area 96 provides an enhanced restraining of an individual as the second limb retained by secondary restraining element 90 is preferably secured against recessed area 96, thereby fixating the limbs of the individual and preventing unwanted movement of the individual and\or any escape attempt.

Preferably, a coupling element 98 is provided or readily coupling restrainer 70

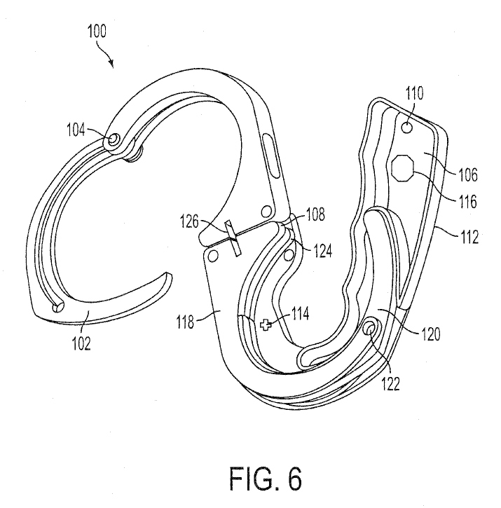

FIG. 6 shows a cross sectional view of a further embodiment of a restrainer 100 according to the present invention.

Restrainer 70 preferably includes a first locking member 102 for readily retaining and/restraining a subject.

For the purpose of rapid deployment of restrainer 100, first locking member 102 is preferably rotatably displaceable about a first hinge 104 in manner similarly used in a variety of law enforcement restraining devices.

Pressure applied on first locking member 102 brings about a complimentary rotational displacement of first locking member 102 about first hinge 104 such that first locking member 102 closes around the wrist, arm or any other bodily part of the subject being restrained.

Preferably a handle 106 is provided for readily applying restrainer 100 and/or manipulating the suspect by creating leverage on the limb or body part of the subject around which restrainer 100 is secured.

A first “ratchet” mechanism 108 similar to such securing mechanism found in hand-cuffs is provided for preventing the subject from removing the restrainer prior to when desired by the retaining government body.

A lanyard loop 110 is provided for readily securing restrainer 100 to as part of the equipment of the law enforcement, military or any other personnel using restrainer 100.

Preferably, lanyard loop 110 is geared towards readily conjoining any number of restrainers 100 to each other for use as handcuffs and/or linking several suspects to each other or even equipment to couriers or escorting individuals.

Preferably, handle 106 is enclosed in at least one, closure 112 which may act as an ergonomic “hand filler” as well.

Preferably, wireless receiver also includes a transmitter 114 for readily locating any individual restrained who may have tried to escape or is secured and/or detained in any location. During military operations, a large number of individuals are often secured and may require control and tracking. Likewise, in many correctional facilities, infractions and even riots can be prevented or quelled rapidly using restrainers 100.

Optionally, a GPS receiver 116 can be attached to, or integrally formed with restrainer 100 for readily locating individuals with extreme accuracy over large areas.

Preferably, an additional limb retainer 118 is attached to, or integrally formed with restrainer 100 such that restrainer 100 can readily be used to restrain and\or secure and\or cuff any two limbs of a single individual and\or suspect or multiple suspects including but not limited to hands, legs, arms, digits and the like.

Preferably and as shown in FIG. 6, restrainer 100 readily accommodates a second restraining element 120. Second restraining element 120 is preferably attached to or integrally formed with restrainer 100 and similarly includes a second hinge 122 for readily securing second restraining element 120 to restrainer 100.

Preferably, a locking mechanism 124 is provided to readily “lock” restrainer 100 thereby readily preventing “tampering” with restrainer 100. Optionally, locking mechanism 124 is analogous to handcuff locking mechanisms known in the art.

Preferably, a coupling element 126 is provided or readily coupling first locking member 102 to second restraining element 120.

Optionally and as shown in FIG. 6, second restraining element includes a second locking member 128 for readily securing a second limb of an individual.

Preferably, an arcuate aperture 130 is formed in second locking member 128 for readily enabling slideably displacing second locking member 128 along second hinge 122, thereby facilitating “compacting” of restrainer 100 in carry and in use.

Optionally, by slideably displacing second locking member 128 along second hinge 122, a user can remove handle 106 leaving first locking member 102 attached to second locking member 128 by way of coupling element 126.

Alternatively, by slideably displacing second locking member 128 along second hinge 122, a user does not remove handle 106, thereby leaving handle 106 coupled to first locking member 102 and second locking member 128 by way of coupling element 126

To any object or other restraining system, including but not limited to, transport systems, chains, leg cuffs, shackles and irons.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It will be appreciated that the above descriptions are intended to only serve as examples, and that many other embodiments are possible within the spirit and scope of the present invention.

What is claimed is:

1. A restrainer comprising:
(a) a claw for readily restraining a subject; and
(b) an activator for bringing about a complimentary displacement of said claw upon pressure being applied on said activator, such that said claw closes around a limb or body part of the subject.

2. The restrainer of claim 1 further comprising a handle.

3. The restrainer of claim 2, wherein said handle is geared towards a usage selected from the group consisting of: a manipulation of the subject, an application of leverage on the suspects limb and securing the subject.

4. A restrainer comprising:
(a) a first locking member; and
(b) a handle geared towards a usage selected from the group consisting of: a manipulation of the subject, an application of leverage on the suspects limb and securing the subject.

5. The restrainer according to claim 4, wherein said first locking member is rotateably displaceable about a hinge in a manner similarly used in a variety of law enforcement restraining devices.

6. The restrainer according to claim 4 further comprising a handle for readily applying said restrainer and/or manipulating the suspect by creating leverage on the limb or body part of the subject around which said restrainer is secured.

7. The restrainer according to claim 4 further comprising a “ratchet” mechanism similar to such securing mechanism found in hand-cuffs is provided for preventing the subject from removing the restrainer prior to when desired by the retaining government body.

8. The restrainer according to claim 4 further comprising a lanyard loop for readily securing said restrainer to any part of the equipment of the law enforcement, military or any other personnel using said.

9. The restrainer according to claim 8, wherein said lanyard loop is geared towards readily conjoining any number of said restrainers to each other for a use selected from the group consisting of: as a set of handcuffs, a linking of several suspects to each other, an secure attachment of equipment to couriers and for an escort of an individual.

10. A restrainer comprising:
(a) a locking member;
(b) a power supply;
(c) a conductive surface for readily applying electrical current similar to “shockers” and other law enforcement products available in the market.

11. The restrainer of claim 10, further comprising:
(d) a handle with formed with a housing for readily accommodating said power supply; and
(e) a wireless receiver for readily remotely activating conductive surface such that once a suspect has been “clamped” remote safe restraining procedures can be implemented.

12. The restrainer of claim 10, further comprising:
(d) a handle with formed with a housing for readily accommodating said power supply.
(e) a transmitter located in said handle for readily locating any individual restrained who may have tried to escape or is secured and/or detained in any location

13. The restrainer of claim 4, further comprising a second locking member coupled to said first locking member.
